(19) United States
(12) Patent Application Publication
(10) Pub. No.: US 2002/0029192 A1
(43) Pub. Date: Mar. 7, 2002

(54) Settlement method and system

(75) Inventors: Masayuki Nakagawa, Tokyo (JP); Masahiro Sakashita, Tokyo (JP); Akira Ishibashi, Tokyo (JP); Shinya Hirata, Tokyo (JP); Masashi Takeda, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd, Tokyo (JP)

(21) Appl. No.: 09/895,858

(22) Filed: Jun. 29, 2001

(30) Foreign Application Priority Data
Jun. 29, 2000 (JP) 2000-196805

(51) Int. Cl. G06F 17/60

(52) U.S. Cl. 705/39; 705/36

(57) ABSTRACT

In accordance with an embodiment of the invention, accounting system terminals of companies having mutual transactions and a bond service handling server at a bond company are interconnected via a network. A company which intends to enter transactions opens, beforehand, a securities deposit account at the bond company by buying investment trust or the like. A company having trade accounts receivable or payable connects its accounting system terminal to the bond service handling server via the network, and requests the server to settle transactions utilizing the securities deposit account. In settling the trade accounts receivable and payable, the requested securities service handling server performs the fund transfer through sale and purchase of bonds, such as investment trust possessed by respective companies, from the proper deposit account, thus, increasing and reducing the balance of the respective securities deposit accounts.

### CROSS-REFERENCES TO RELATED APPLICATIONS

This application claims priority from Japanese Patent Application No. 2000-196805, filed Jun. 29, 2000, which disclosure is incorporated herein by reference.

### BACKGROUND OF THE INVENTION

The present invention relates to a settlement method and system, and more particularly to a settlement method and system capable of settling trade accounts receivable and payable at a cheaper handling charge than a bank transfer charge.

Generally, when transactions such as purchase and sale are made, particularly transactions between companies, payment to a seller is prolonged in some cases. In such cases, the seller has a credit of accounts receivable and the purchaser has a debt of accounts payable. Generally, the purchaser pays for the purchased goods by money transfer to a bank account of the seller.

FIG. 5 is a diagram of a conventional settlement method through bank transfer. FIG. 5, shows a seller terminal 11 belonging to a seller A, a purchaser terminal 12 belonging to a purchaser B, a network 13, a bank, a bank service handling apparatus 22, a deposit account of seller A 23, and a deposit account of purchaser B 24.

In the system shown in FIG. 5, seller terminal 1, purchaser terminal 12 and bank service handling apparatus 22 at the bank 21 are interconnected via network 13. which can be, for example, public telephone lines or the internet. Seller A sells products to purchaser B. As a result, seller A has a trade credit of accounts receivable and purchaser B has a trade debt of accounts payable.

Purchaser B having the debt of accounts payable connects purchaser terminal 12 to bank service handling apparatus 22 at the bank 21 via network 13, and asks bank service handling apparatus 22 to transfer money corresponding to the accounts payable amount from purchaser B's deposit account 24 to the seller A's deposit account 23.

The bank service handling apparatus 22 asked to transfer money subtracts the amount from the balance of purchaser B's deposit account 24. In this case, a transfer charge from bank 21 is also subtracted from the balance of purchaser B's deposit account 24. The transfer handling charge is reckoned as revenue of bank 21. Next, bank service handling apparatus 22 adds the transfer amount to the balance of seller A's deposit account 23 and notifies seller A of the amount transferred to seller A's deposit account 23.

A settlement method by transfer settles a payment from a purchaser to a seller by increasing/decreasing the respective deposit balances, upon request from the purchaser.

### BRIEF SUMMARY OF THE INVENTION

In order to participate in transaction settlement by bank account transfer, the concerned parties are required to open demand deposit accounts. However, the procedure has disadvantages; for example, a check that is deposited for settling future transaction does not earn interest while in the account, so that no investment profit can be obtained from settlement funds. Another problem is that a transfer charge is incurred every time a settlement is processed by bank account transfer.

Therefore, it is an object of the invention to provide a settlement method and system which uses a securities account as a settlement account and which can reduce the transfer charge and provide investment profit.

Accordingly, the present invention provides a settlement system connected to user terminals for settling a transaction made between users. The system comprises a storage means for storing user information, data representative of each of the securities possessed by each user, and a coefficient for calculating the value of each of the securities, in relation to each other; a reception means for receiving settlement request information from a user terminal of a debtor in a transaction, the settlement request information including the user identification information of the debtor, the user identification information of the creditor, and payment amount information representative of the amount to be paid by the debtor to the creditor; and settlement means for obtaining the securities data of the debtor from securities data stored in the storage means, and for storing the selected securities data in association with the user identification information of the creditor.

Other advantages and features of the present invention will be apparent from the accompanying drawings and the description thereof.

### BRIEF DESCRIPTION OF THE DRAWINGS

FIG. 1 is a block diagram showing the structure of a settlement system according to an embodiment of the invention.

FIG. 2 is a flow chart of the processes at the site of seller A, which holds the accounts receivable following a transaction, in accordance with an embodiment of the invention.

FIG. 3 is a flow chart of the processes at the site of purchaser B, which holds the accounts payable following a transaction, in accordance with an embodiment of the invention.

FIG. 4 is a flow chart of the processes at the site of a securities company, in accordance with an embodiment of the invention.

FIG. 5 is a diagram showing a system structure of a conventional settlement method utilizing a bank transfer process.

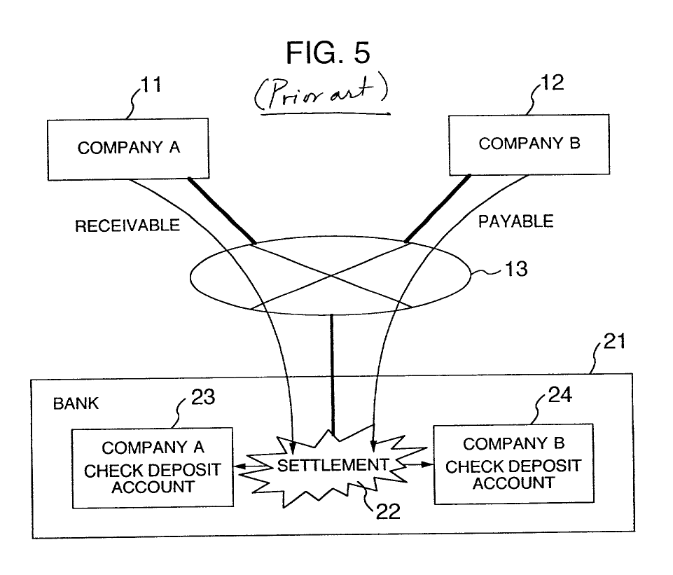

FIG. 6 is a block diagram showing the structure of a securities service handling apparatus at a securities company, in accordance with an embodiment of the invention.

FIG. 7 shows the data structure of a storage unit connected to a securities service handling apparatus, in accordance with an embodiment of the invention.

FIG. 8 is a flow chart illustrating the process of verifying a received settlement request, the process being executed by the securities service handling apparatus, in accordance with an embodiment of the invention.

### DETAILED DESCRIPTION OF THE INVENTION

A settlement system according to an embodiment of the invention is described in detail with reference to the accompanying drawings.

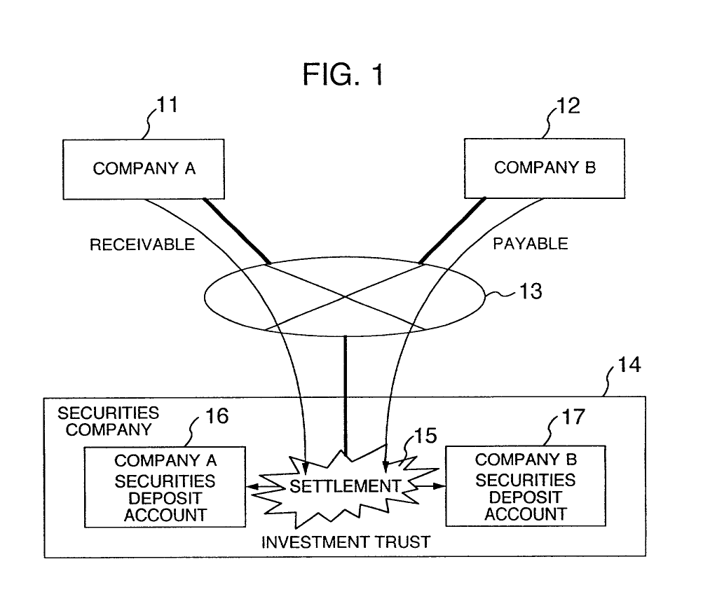

The settlement system shown in FIG. 1 includes, a securities company 14, a securities service handling apparatus 15, a securities deposit account 16 opened at securities company 14 by a seller A, a securities deposit account 17 opened at securities company 14 by a purchaser B, a seller terminal 11, and a purchaser terminal 12.

In this specification, a terminal possessed by the party holding accounts receivable in a business transaction is called the seller terminal 11 and a terminal possessed by the party holding the accounts payable in a business transaction is called the purchaser terminal 12. However, the transactions applicable to the settlement system of the present invention are not limited only to the sale and purchase example used in this description.

As shown in FIG. 1, in the settlement system of this embodiment, seller A terminal 11, purchaser B terminal 12 and securities service handling apparatus 15 at securities company 14 are interconnected by a network 13 such as public telephone lines, or the internet. It is assumed that seller A and purchaser B have already opened securities deposit accounts at securities company 14.

Although not shown, seller terminal 11 has an input unit for inputting charge data, an output unit for outputting settlement particulars, and a transceiver unit for transmitting and receiving information to and from securities service handling apparatus 15 via network 13.

In addition, although not shown, purchaser terminal 12 has an input unit for inputting settlement request data, an output unit for outputting settlement particulars, and a transceiver unit for transmitting and receiving information to and from the securities service handling apparatus 15 via the network 13. Seller terminal 11 and purchaser terminal 12 may have the same structure.

The charge data is data transmitted by seller A from seller terminal 11 to securities service handling apparatus 15. The charge data includes: seller identification information identifying seller A; transaction identification information identifying a transaction between seller A and purchaser B; purchaser identification information identifying purchaser B; charge amount information representative of the amount which is claimed by seller A from purchaser B for the identified transaction; due date information representative of the settlement term agreed upon by purchaser B and seller A; and other information.

The settlement request data is transmitted by purchaser B from purchaser terminal 12 to securities service handling apparatus 15. The settlement request data includes: the identification information for identifying seller A; transaction identification information; the purchaser identification information of purchaser B; settlement amount information representative of the amount to be paid by purchaser B to seller A for the identified transaction ; due date information representative of the settlement term agreed upon by purchaser B seller A; and other information.

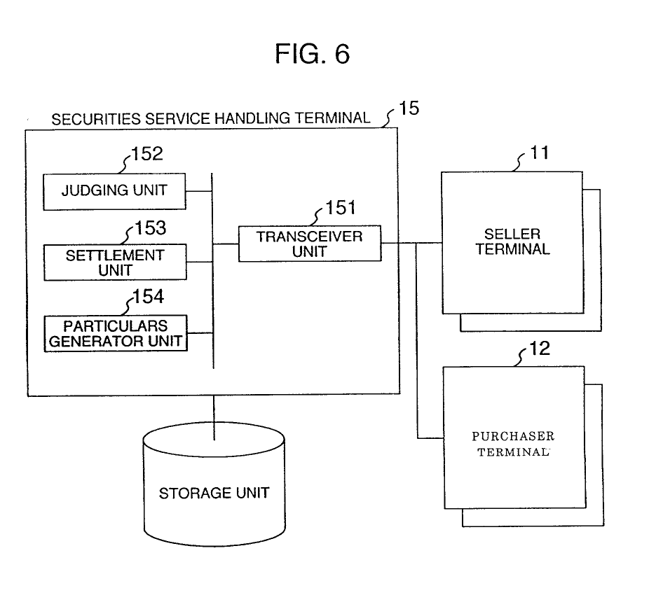

FIG. 6 shows the structure of securities service handling apparatus 15 installed at securities company 14. Securities service handling apparatus 15 has a transceiver unit 151, a judging unit 152, a settlement unit 153, and a particulars generator unit 154, and is connected to a storage unit 155. Judging unit 152 determines whether settlement is to be made, in accordance with the settlement request data transmitted from purchase terminal 12 and the charge data transmitted from seller terminal 11. Transceiver unit 153 transmits and receives information to and from seller terminal 11 and purchaser terminal 12. If judging unit 152 determines that settlement is to be made, in accordance with account balance information and information representative of the value of each of the securities handled by securities company 14, settlement unit 153 calculates the kind and value of securities which are subtracted from purchaser B's securities deposit account 24 and are added to seller A's securities deposit account 23. In accordance with the calculation results, settlement unit 153 transfers securities of a predetermined kind and value from securities deposit account 24 of purchaser B to securities deposit account 23 of seller A. Particulars generator unit 154 generates settlement particulars data for each of seller terminal 11 and purchaser terminal 12.

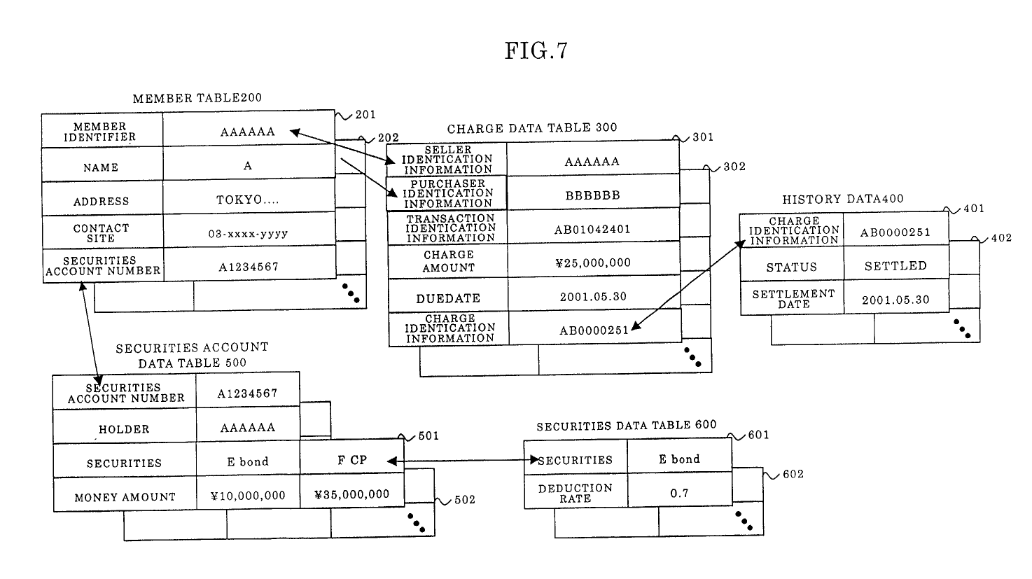

FIG. 7 is a diagram showing the configuration of the data to be stored in the storage unit 155 connected to securities service handling apparatus 15. Storage unit 155 stores therein member tables 200 (201, 202, . . . ), charge data tables 300 (301, 302, . . . ), history data tables 400 (401, 402, . . . ), securities account data tables 500 (501, 502, . . . ), and securities data tables 600 (601, 602, . . . ), respectively, in relation to each other.

Member table 200 stores information (such as member identification information, name, address, contact site, securities account number) about each member that is a seller or purchaser in the settlement system of this embodiment. Charge data table 300 stores charge data for seller A to request payment from purchaser B (e.g., member identification information of the seller A, member identification information of the purchaser B, transaction identification information, charge amount information, due date information, and charge identification for identifying each charge data. History data table 400 stores information on the status of each charge data stored in the charge data table (such as charge identification information; status information, which is a flag indicating whether settlement has already been made; and information representative of a payment date if the settlement has already been made). Securities account data table 500 stores information about the securities deposit account of each member (such as account identification information for identifying an account, member identification information representative of the holder of a securities account, securities possessed by the account and their values). Securities data table 600 stores the type of each of the securities handled by the securities company 14 and the discount rate of each of the securities, for converting the denomination thereof to a current value.

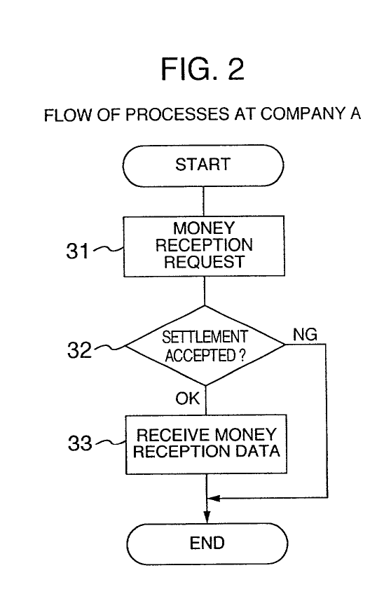

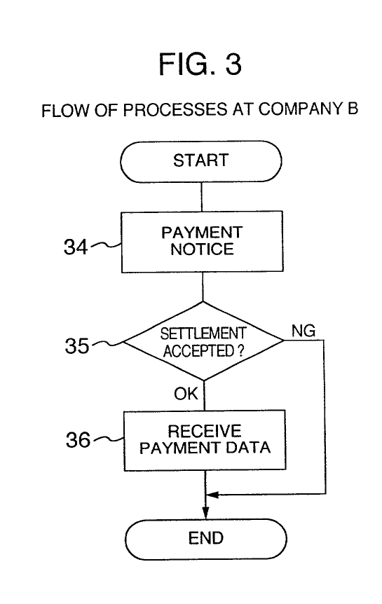

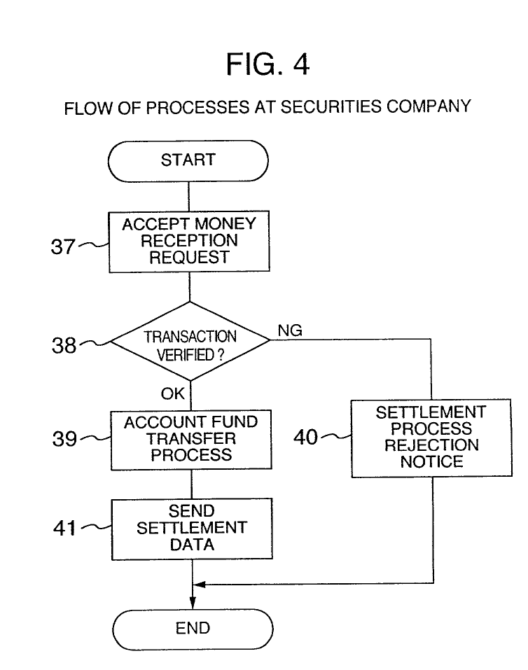

When a transaction is made between seller A and purchaser B, seller A acquires a trade credit as accounts receivable and the purchaser B incurs trade debt as accounts payable. Transactional flow of the settlement system shown in FIG. 1 is now described with reference to FIGS. 2-4 which illustrate the processes executed at seller terminal 11, purchaser terminal 12, and securities service handling apparatus 15. Since the processes at each step shown in FIGS. 2-4 are executed collaboratively, the following description collectively refers to these figures.

Purchaser B, who has incurred trade debt as accounts payable, or the seller A, who has acquired trade credit as accounts receivable, connects purchaser terminal 12 or seller terminal 11 to securities service handling apparatus 15 at securities company 14 via network 13, and transmits a settlement request using a securities deposit account (Steps 31 or 34).

If securities service handling apparatus 15 at securities company 14 accepts the settlement request (Step 37), it is necessary to confirm whether the transaction was closed because securities are sold and brought for the settlement. For example, this confirmation may be made by having purchaser B send a certification of accounts payable and having seller A transmit accounts receivable together with a settlement request to securities service handling apparatus 15. Alternatively, both seller A and purchaser B can transmit their certifications and settlement requests to securities service handling apparatus 15, which also can verify the settlement requests received from the seller terminal 1 1 and purchaser terminal 12. (Steps 38 and 40).

Upon receipt of a settlement request, securities service handling apparatus 15 makes a settlement between the seller A and purchaser B by increasing and reducing the balances of the securities deposit accounts of the seller A and purchaser B, respectively. (Step 39).

Securities service handling apparatus 15 sends notice of the completion of the settlement process to seller A and purchaser B, and seller A and purchaser B receive money reception data and payment data (Steps 41, 33 and 36).

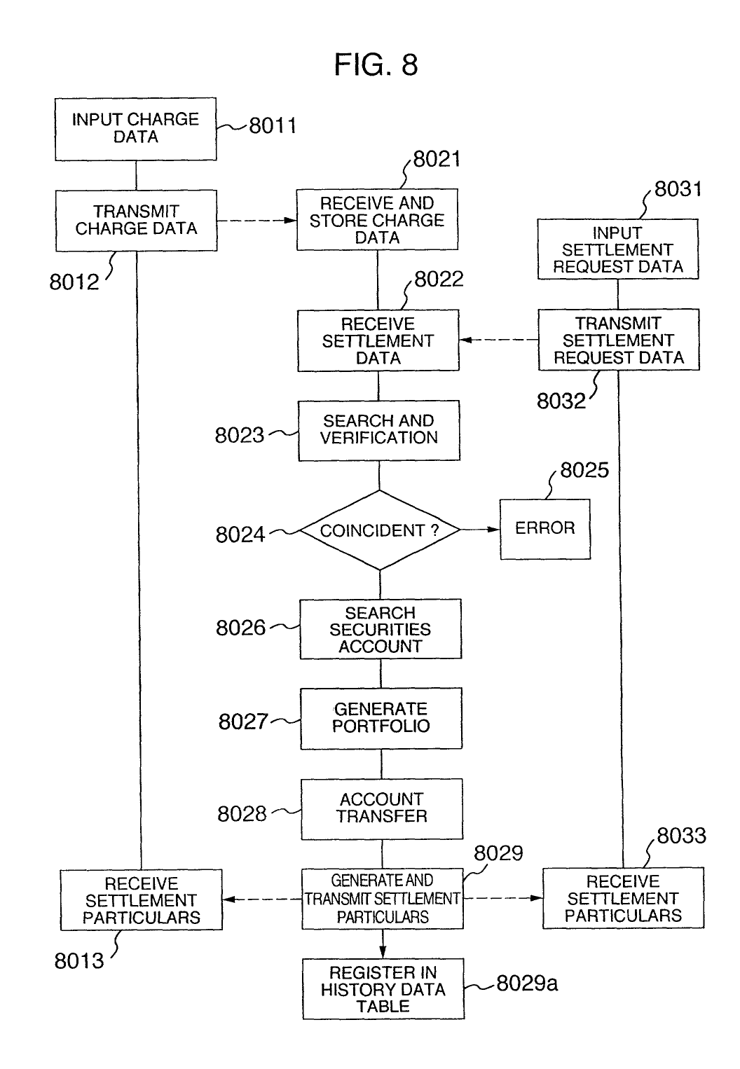

Each process to be executed by the settlement system of the embodiment shown in FIG. 1 is now described in detail with reference to FIG. 8, which is a flow chart of the process of verifying the settlement requests received from the seller terminal 11 and purchaser terminal 12. The process is executed by securities service handling apparatus 15.

Seller A acquires accounts receivable trade credit through a transaction and inputs charge data from seller terminal 11 (Step 8011). The transceiver at seller terminal 11 transmits the charge data to securities service handling apparatus 15 (Step 8012).

Transceiver 151 at securities service handling apparatus 15 receives the charge data from seller terminal 11, adds the charge identification information to the received charge data, and stores the data in storage unit 155, which is connected to apparatus 15 (Step 8021).

Purchaser B incurs trade debt as accounts payable in the transaction in question and inputs settlement request data from purchaser terminal 12 (step 8031). The settlement request data contains purchaser B's member identification information (purchaser identification information), seller A's member identification information as the seller that is to receive payment (seller identification information), transaction identification information for identifying a transaction between purchaser B and seller A, and information representative of a payment amount (Step 8031).

Transceiver 151 of securities service handling apparatus 15 receives settlement request data from purchaser terminal 12 (Step 8022), and judging unit 152 searches the charge data stored in storage unit 155 by using the seller identification information and transaction identification information contained in the settlement request data as search keys (Step 8023). Judging unit 152 compares the searched charge data with the settlement request data (Step 8024), and if they are not coincident, it is judged as an error and the processes ends (Step 8025).

If the verification result at Step 8024 indicates coincidence, settlement unit 153 of securities service handling apparatus 15 searches the securities account data of the purchaser B in storage unit 155 by using the purchaser identification information contained in the settlement request data as a search key (step 8026). Settlement unit 153 generates a portfolio having the same present value as the payment amount. The portfolio is composed of securities held in the securities account. The settlement unit 153 generates the portfolio in accordance with data about one or more of the securities contained in the searched securities account data, reduction rate data corresponding to each of the securities, and the payment amount designated by the settlement request data (Step 8027). Settlement unit 153 subtracts the generated portfolio from the securities account of purchaser B, and increases the amount of the securities account of seller A (corresponding to the seller identification information) (Step 8028).

Particulars generator unit 154 of securities service handling apparatus 15 generates settlement particulars, transmits them to seller terminal 11 and purchaser terminal 12 (Step 8029), and stores the settled charge data in the history data table (Step 8029a). In addition to the information explicitly shown in history data table 400 in FIG. 7, other information about the settlement, such as the type and amount of securities transferred, the values of such securities at the time of transfer, and the like are also maintained in history data table 400.

Programs for executing the operations of the securities service server 15 may be provided by storing them in a portable storage medium such as a magnetic disk and/or an optical disk.

With the settlement method according to the embodiment of the invention, as described above, a bond company which deals with settlements can obtain investment profit without any handling charge, because the balance of securities accounts managed by the company will not change. Even if a handling charge for the labor cost of increasing and reducing the balance of securities deposit accounts is incurred, this charge can be set considerably lower than a bank transfer charge. Therefore, a securities company providing the settlement method according to the embodiment of the invention can maintain and increase trust (securities) funds and an increase in revenues can be expected.

A company or the like which requests settlement can settle accounts receivable and payable with no charge or at a smaller charge, and, in addition, can obtain investment profit from securities, such as occurs in an investment trust, unless the balance of securities deposit account drops to zero.

While the present invention has been particularly shown and described with reference to the preferred embodiments, it will be understood that the various changes and modifications will occur to those skilled in the art without departing from the scope and true spirit of the invention. The scope of the invention is therefore to be determined solely by the appended claims.

What is claimed is:

1. A settlement system connected to user terminals for settling a transaction made between users, comprising:
storage means for storing user identification information for identifying each user, data representative of each of securities possessed by each user, and a coefficient for calculating a value of each of the securities, respectively in correspondence with each other;
reception means for receiving settlement request information from a user terminal of a debtor of a transaction, the settlement request information including the user identification information of the debtor of the transaction, the user identification information of a creditor of the transaction, and payment money amount information representative of a money amount to be paid from the debtor to the creditor; and
settlement means for deriving securities data of the debtor from the securities data stored in said storage means, in accordance with the user identification information of the debtor contained in the settlement request information, for selecting each of the securities data in accordance with the derived securities data, the coefficient corresponding to the derived securities data, and the money amount to be paid, and for storing the selected securities data in correspondence with the user identification information of the creditor.

2. A settlement system according to claim 1, further comprising a judging unit for comparing charge data received from the user terminal of the creditor with the settlement request data, and if the comparison result indicates a coincidence, deriving the securities data of the creditor from said storage means.

3. A settlement system according to claim 2, further comprising a particulars generator unit for generating settlement particulars data in accordance with a result of settlement by said settlement means.

4. A settlement system according to claim 2, wherein the coefficient for calculating the value is a reduction rate for calculating a current value of a denomination of each of the securities.

5. A settlement system according to claim 4, wherein a current value of a total denomination of the securities selected by said settlement means is equal to the money amount to be paid.

6. A settlement system connected to a purchaser terminal of a purchaser and a seller terminal of a seller for settling a transaction made between the purchaser and seller, comprising:
storage means for storing user identification information for identifying the purchaser, user identification information for identifying the seller, data representative of each of securities possessed by the purchaser, data representative of each of securities possessed by the seller, and a coefficient for calculating a value of each of the securities, respectively in correspondence with each other;
reception means for receiving settlement request information from the purchaser user terminal, the settlement request information including the purchaser identification information, the seller identification information, and payment money amount information representative of a money amount to be paid from the purchaser to the seller;
settlement means for selecting each of securities data in accordance with securities data stored in correspondence with the purchaser identification information, the coefficient stored in correspondence with the purchaser identification information, and the payment money amount, and for storing the selected securities data in correspondence with the seller identification information.

7. A settlement method for a settlement system connected to a plurality of user terminals for settling a transaction made between users, said method executed by said settlement system comprising the steps of:
storing in storage means user identification information for identifying each user, data representative of each of securities possessed by each user, and a coefficient for calculating a value of each of the securities, respectively in correspondence with each other;
receiving from said storage means settlement request information from a user terminal of a debtor of a transaction, the settlement request information including the user identification information of the debtor of the transaction, the user identification information of a creditor of the transaction, and payment money amount information representative of a money amount to be paid from the debtor to the creditor; and
deriving securities data of the debtor from the securities data in accordance with the user identification information of the debtor contained in the settlement request information, selecting each of the securities data in accordance with the derived securities data, the coefficient corresponding to the derived securities data, and the payment money amount, and storing the selected securities data in correspondence with the user identification information of the creditor.

8. A settlement method according to claim 7, wherein charge data representative of the contents of payment request from the creditor to the debtor is received from the user terminal of the creditor, the charge data is compared with the settlement request data, and if the comparison result indicates a coincidence, the securities data of the debtor is read from said storage means.

9. A settlement method according to claim 8, wherein a correspondence between the selected securities data and the user identification information of the creditor is notified to the user terminals of the debtor and creditor.

10. A settlement method according to claim 9, wherein the coefficient for calculating the value is a reduction rate for calculating a current value of a denomination of each of the securities.

11. A settlement method according to claim 10, wherein a current value of a total denomination of the selected securities is equal to the payment money amount.
